(19) United States
(12) Patent Application Publication
(10) Pub. No.: US 2014/0160372 A1
(43) Pub. Date: Jun. 12, 2014

(54) TOUCH PANEL

(71) Applicant: WINTEK CORPORATION, Taichung City (TW)

(72) Inventors: Chong-Wei Li, Changhua County (TW); Wen-Chun Wang, Taichung City (TW); Ching-Fu Hsu, Taichung City (TW); Chong-Yang Fang, Taichung City (TW); Rone-Hwa Chou, Nantou County (TW); Cheng-Yi Chou, Yunlin County (TW); Chang-Hsuan Hsu, Changhua County (TW)

(73) Assignee: WINTEK CORPORATION, Taichung City (TW)

(21) Appl. No.: 14/098,541

(22) Filed: Dec. 6, 2013

(30) Foreign Application Priority Data
Dec. 7, 2012 (TW) 101146216

(51) Int. Cl. G06F 1/16

(52) U.S. Cl. CPC G06F 1/1692
USPC 349/12

(57) ABSTRACT

A touch panel includes a substrate, at least one first axis electrode, and at least one second axis electrode. The first axis electrode is disposed on the substrate and extends along a first direction. The first axis electrode includes at least one first mesh. The second axis electrode is disposed on the substrate and extends along a second direction. The second axis electrode includes at least one second mesh. The first axis electrode at least partially overlaps the second axis electrode along a direction perpendicular to the substrate. An aperture ratio of a region where the first axis electrode overlaps the second axis electrode is substantially equal to an aperture ratio of a region where the first axis electrode does not overlap the second axis electrode.

### BACKGROUND OF THE INVENTION

1. Field of the Invention

The present invention generally relates to a touch panel, and more particularly, to a touch panel having electrodes composed of meshes.

2. Description of the Prior Art

Nowadays, mobile phones, GPS navigator system, tablet PCs, personal digital assistants (PDAs) and laptop PCs with touch functions are wildly used in modern life. In the above-mentioned electronic products, the touch display devices can be obtained by integrating the original display function with the touch sensing function. Nowadays, an out-cell touch display panel, which includes a display panel and a touch panel adhered to each other, is one of the mainstream development in the field of the touch display devices.

In recent times, various technologies have been developed in the field of the touch panels. Generally, the different types of touch panels include the resistance type, the capacitance type and the optical type. Owing to its outstanding characteristics, such as high accuracy, multi-touch property, better endurance and high touch resolution, the capacitive touch panel has become a mainstream technology in the high, middle end consumer electronic products. The capacitive touch panel uses sensing electrodes to detect capacitance variations at the corresponding touch points and uses connection lines, which are electrically connected to electrodes along different directional axes, to transmit the generated signals so as to complete the whole touch sensing and positioning process. In conventional capacitive touch panels, the composition of the sensing electrodes generally comprises transparent materials, such as indium tin oxide (ITO). Since the resistance of transparent materials is higher than that of metals, the response speed is negatively affected in the touch panels that use transparent materials as sensing electrodes. Therefore, meshes composed of woven conductive lines have been invented to replace conventional transparent conductive materials as sensing electrodes. The touch panel with these meshes can provide better response speed. However, an aperture ratio of the touch panel with the meshes is generally low since the meshes of the corresponding sensing electrodes in different directions are prone to interact with each other in overlapped regions. As a result, these overlapped regions negatively affect the appearance of the touch panel.

### SUMMARY OF THE INVENTION

One objective of the present invention is to provide a touch display using meshes to form different axis electrodes. By adjusting the shape of the meshes or the bridge lines, an aperture ratio of the region where different axis electrodes overlap each other is substantially equal to an aperture ratio of the region where different axis electrodes do not overlap each other. In this configuration, the appearance of the touch panel with meshes can be improved.

To this end, a touch display device is provided. The touch panel includes a substrate, at least one first axis electrode, and at least one second axis electrode. The first axis electrode is disposed on the substrate and extends along a first direction. The first axis electrode includes a plurality of first meshes. The second axis electrode is disposed on the substrate and extends along a second direction. The second axis electrode includes a plurality of second meshes. The first axis electrode at least partially overlaps the second axis electrode along a direction perpendicular to the substrate. An aperture ratio of a region where the first axis electrode overlaps the second axis electrode is substantially equal to an aperture ratio of a region where the first axis electrode does not overlap the second axis electrode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a touch panel according to a first preferred embodiment of the present invention.

FIG. 2 is a schematic cross-sectional diagram taken along a line A-A′ in FIG. 1.

FIG. 3 and FIG. 4 are schematic diagrams showing a method for manufacturing a touch panel according to a second preferred embodiment of the present invention.

FIG. 5 is a partially enlarged schematic diagram of FIG. 4.

FIG. 6 is a schematic cross-sectional diagram taken along a line B-B′ in FIG. 5.

FIG. 7 is a schematic cross-sectional diagram taken along a line C-C′ in FIG. 5.

FIG. 8 is a schematic diagram showing a touch panel according to a third preferred embodiment of the present invention.

FIG. 9 and FIG. 10 are schematic diagrams showing a method for manufacturing a touch panel according to a fourth preferred embodiment of the present invention.

### DETAILED DESCRIPTION

To provide a better understanding of the present invention to those skilled in the technology of the present invention, various preferred embodiments will be detailed as follows. The preferred embodiments of the present invention are illustrated in the accompanying drawings with numbered elements to elaborate the contents and effects to be achieved.

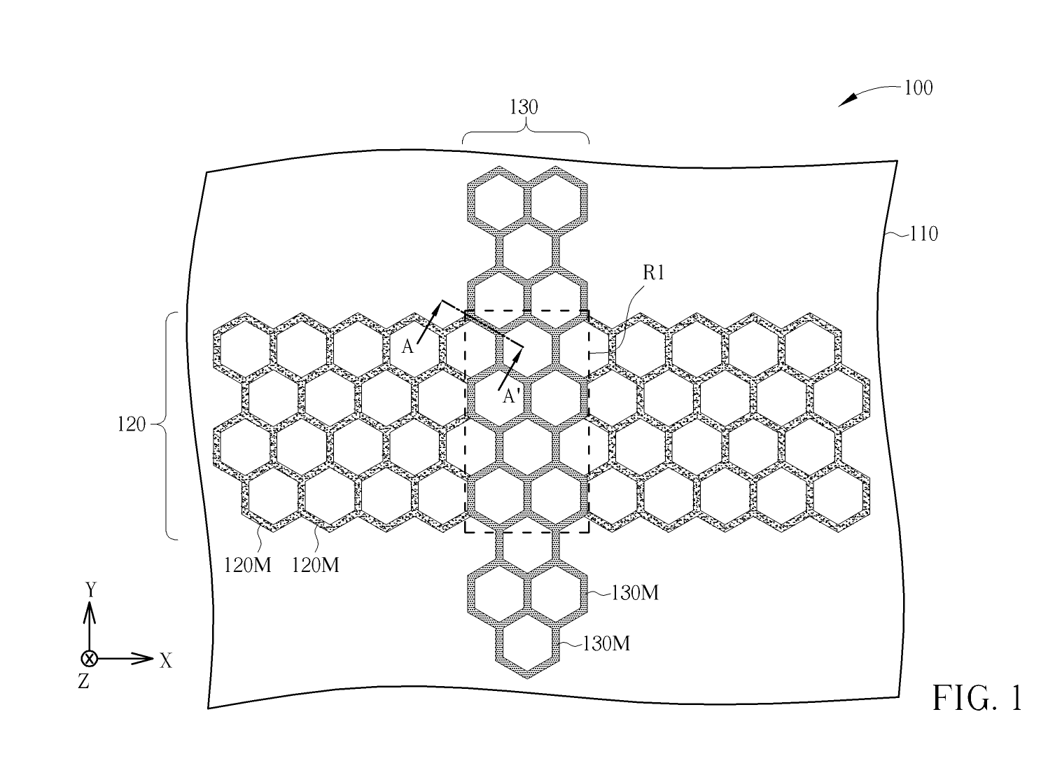

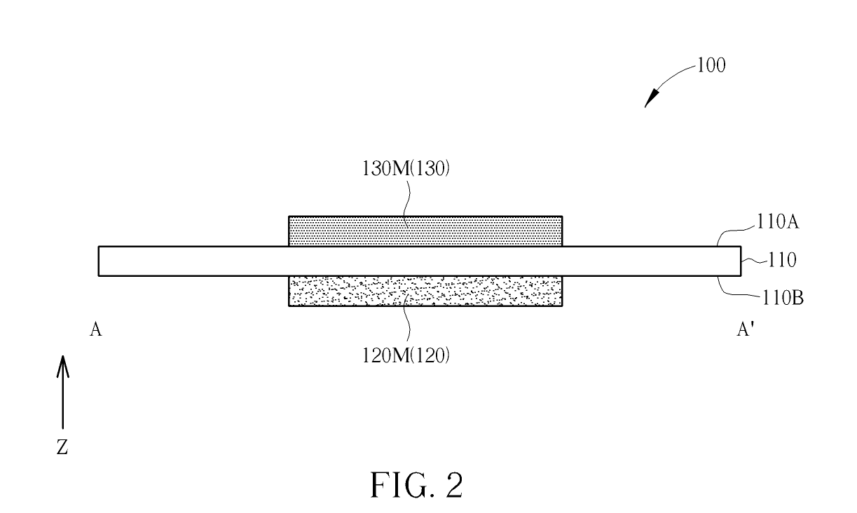

FIG. 1 is a schematic diagram showing a touch panel according to a first preferred embodiment of the present invention. FIG. 2 is a schematic cross-sectional diagram taken along a line A-A′ in FIG. 1. For the sake of clarity, the relative dimensions and size of various components depicted in the figures do not reflect actual dimensions and can be modified in order to achieve the design requirements. As shown in FIG. 1 and FIG. 2, the present embodiment provides a touch panel 100. The touch panel 100 includes a substrate 110, at least a first axis electrode 120 and at least a second axis electrode 130. The substrate 110 may include a rigid substrate, such as a glass substrate and a ceramic substrate, a flexible substrate, such as a plastic substrate, or other suitable substrate. The first axis electrode 120 is disposed on the substrate 110 and extends along a first direction X. The first axis electrode 120 includes a plurality of first meshes 120M. The second axis electrode 130 is disposed on the substrate 110 and extends along a second direction Y. The second axis electrode 130 includes a plurality of second meshes 130M. The first direction X is preferably perpendicular to the second direction Y, but not limited thereto. It should be noted that, only one first axis electrode and one second axis electrode are depicted in each figure for the sake of brevity, but not limited thereto. That is to say, a plurality of first axis electrodes and a plurality of second axis electrodes may be formed, if required, according to the present invention. According to this embodiment, the first axis electrode 120 at least partially overlaps the second axis electrode 130 along a direction Z perpendicular to the substrate 110. An aperture ratio of a region R1 where the first axis electrode 120 overlaps the second axis electrode 130 is substantially equal to an aperture ratio of a region where the first axis electrode 120 does not overlap the second axis electrode 130.

More specifically, as shown FIG. 1 and FIG. 2, the first axis electrode 120 is disposed on a lower surface 110B of the substrate 110, and the second axis electrode 130 is disposed on an upper surface 110A of the substrate 110 opposite to the lower surface 110B. That is to say, the first axis electrode 120 and the second axis electrode 130 are respectively disposed on the different surfaces of the substrate 110, but not limited thereto. According to other preferred embodiments of the present invention, the first axis electrode 120 and the second axis electrode 130 may be respectively formed on two different substrates. Subsequently, a touch panel can be formed by combining these two substrates through an adhesion process. According to another preferred embodiment of the present invention, an isolation layer may be disposed between the first axis electrode and the second axis electrode so as to electrically isolate the first axis electrode from the second axis electrode. According to the present embodiment, all the first meshes 120M of the first axis electrode 120 are connected to one another. Similarly, according to the present embodiment, all the second meshes 130M of the second axis electrode 130 are connected to one another. Preferably, the shape of each first mesh 120M and each second mesh 130M are the same, and may be a regular shape, such as a right hexagon, but not limited to this. According to other preferred embodiments, the shape of the each first mesh 120M and each second mesh 130M may be regular or irregular. In a region R1 where the first axis electrode 120 overlaps the second axis electrode 130, the first meshes 120M overlap the corresponding second meshes 130M and their shape are the same along the direction Z perpendicular to the substrate 110. In this configuration, an aperture ratio of a region where each first mesh 120M overlaps each second mesh 130M is substantially equal to an aperture ratio of a region where each first mesh 120M does not overlap each second mesh 130M. That is to say, the first meshes 120M and the second meshes 130M disclosed in the present embodiment have the same size and shape so that the aperture ratio of the region R1, where the first axis electrode 120 overlaps the second axis electrode 130, can be improved and the negative effects resulting from the interaction between the first meshes 120M and the second meshes 130M will not occur. It is worth noting that, considering the variations in the alignment process for respectively manufacturing the first axis electrode 120 and the second axis electrode 130 on the upper surface and the lower surface of the substrate 110, the difference in the aperture ratio between the region R1, where the first axis electrode 120 overlaps the second axis electrode 130, and the region, where the first axis electrode 120 does not overlap the second axis electrode 130, is preferably lower than 5%. In this configuration, the aperture ratio in the region R1 and the appearance of the touch panel 100 can be improved.

In addition, the first axis electrode 120 and the second axis electrode 130 disclosed in this embodiment preferably includes conductive materials, such as at least one chosen from gold (Au), aluminum (Al), copper (Cu), silver (Ag), chromium (Cr), titanium (Ti), molybdenum (Mo) and neodymium (Nd), or an alloy thereof. Each of the first axis electrode 120 and the second axis electrode 130 may be a single-layered electrode or a composite-layered electrode made of the above-mentioned material or alloy, but not limited thereto. Other conductive materials, such as conductive metal oxides or composites composed of conductive metal oxides and metal or alloys, may also be used. Furthermore, the above mentioned composites may be three-layered stack structures composed of Mo, Mo—Nd alloy, and Mo, or composed of indium tin oxide (ITO), silver, and ITO, but not limited thereto. That is to say, any stack structure that can provide the desired conductive properties is within the scope of the present invention. The first meshes 120M and the second meshes 130M preferably have the same line width, which is substantially less than 10 micrometers (pm), and more preferably, the first meshes 120M and the second meshes 130M have a line width less than 8 μm. It's better that the first meshes 120M and the second meshes 130M have a line width ranging from 2 μm to 3 μm, but not limited thereto and can be applied to other embodiments herein. Additionally, the first axis electrode 120 and the second axis electrode 130 may be respectively a touch signal transmitting electrode and a touch signal receiving electrode so as to respectively transmit and receive the touch sensing signals. That is to say, the touch panel 100 may be a mutual capacitive touch panel, but not limited thereto. The touch panel 100 disclosed in the present invention uses the first meshes 120M and the second meshes 130M to respectively form the first axis electrode 120 and the second axis electrode 130. Additionally, the shapes of the first meshes 120M and the second meshes 130M may be adjusted in order to lower the change in the aperture ratio of the region R1 where the first axis electrode 120 overlaps the second axis electrode 130. Accordingly, even though the first meshes 120M and the second meshes 130M are used in the touch panel 100 in order to improve its touch response speed, the appearance of the touch panel 100 will still not be affected negatively.

In the following paragraphs, various embodiments are disclosed and the description of these embodiments is mainly focused on differences among one another. In addition, like or similar features will usually be described with same reference numerals for ease of illustration and description thereof.

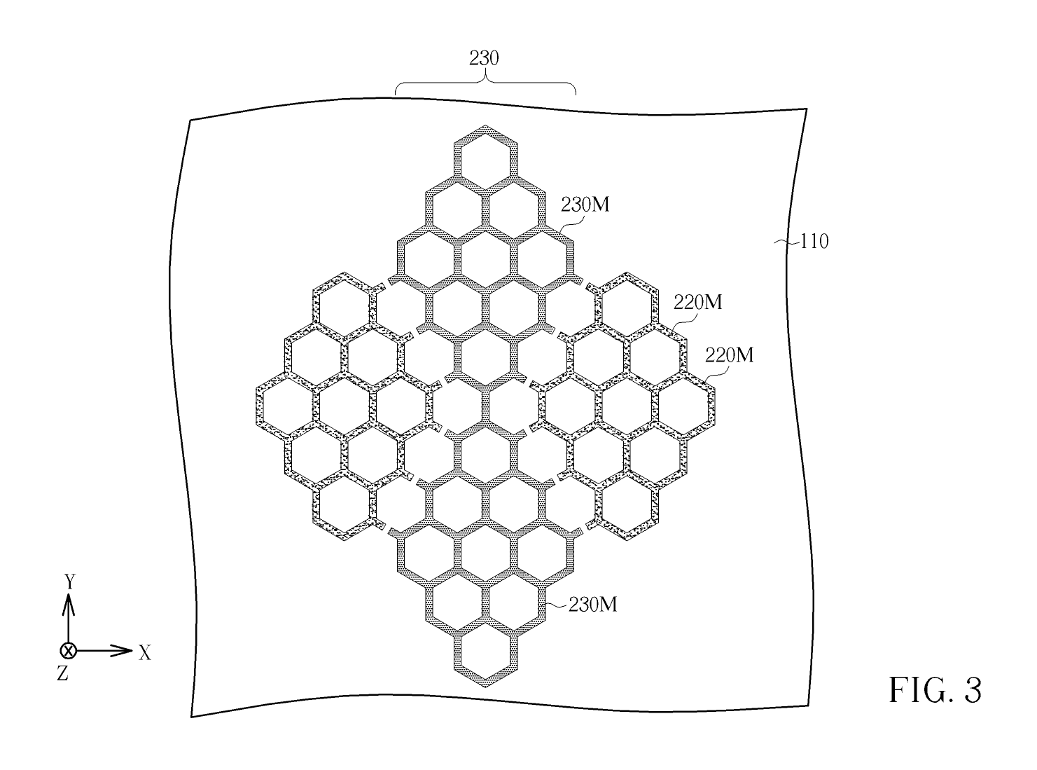

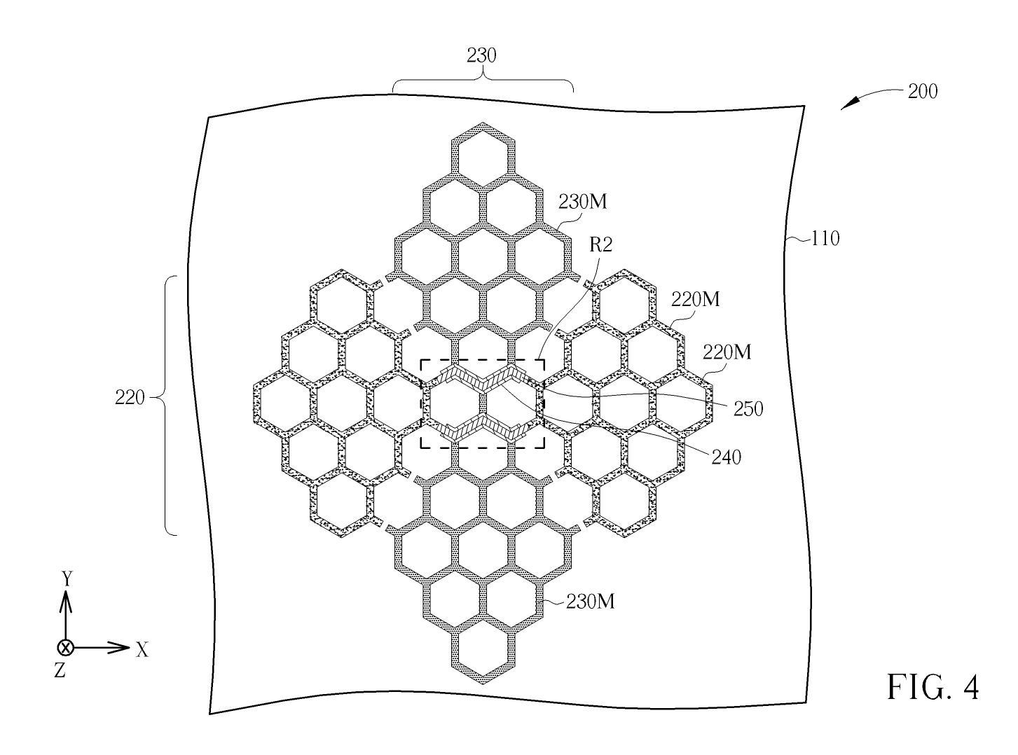

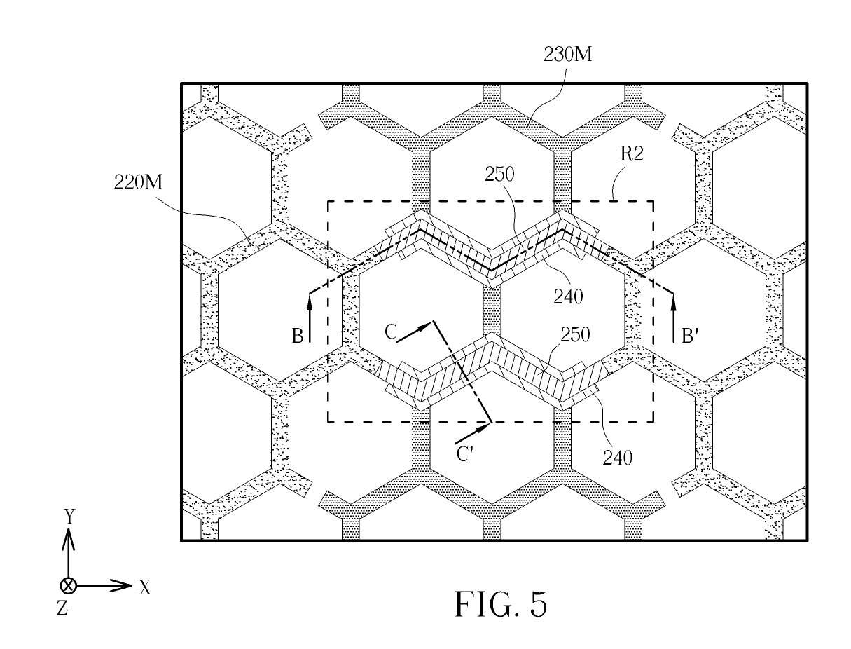

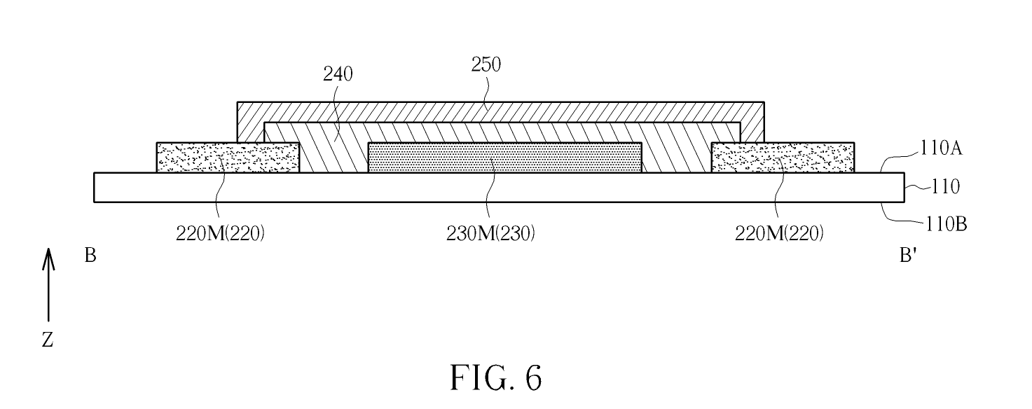

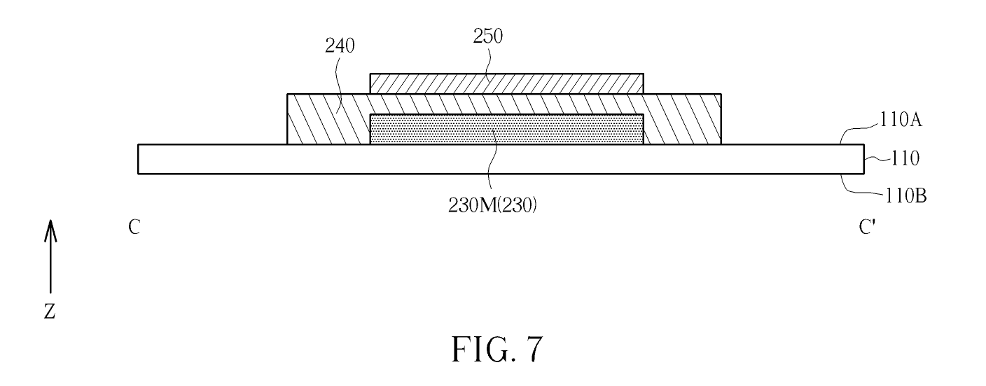

Please refer to FIG. 3 to FIG. 7. FIG. 3 and FIG. 4 are schematic diagrams showing a method for manufacturing a touch panel according to a second preferred embodiment of the present invention. FIG. 5 is a partially enlarged schematic diagram of FIG. 4. FIG. 6 is a schematic cross-sectional diagram taken along a line B-B′ in FIG. 5. FIG. 7 is a schematic cross-sectional diagram taken along a line C-C′ in FIG. 5. First, as shown in FIG. 3, a plurality of first meshes 220M and a second axis electrode 230 are formed on the substrate 110. The second axis electrode 230 includes a plurality of connected second meshes 230M. At least a portion of the first meshes 220M is separated from the other ones. That is to say, the first meshes 220M and the second meshes 230M disclosed in the present embodiment can be formed concurrently through pattering a material layer, but not limited to this. Subsequently, as shown in FIG. 4, an isolation block 240 and a bridge line 250 are formed sequentially. The bridge line 250 is used to electrically connect two separated first meshes 220M so as to comprise a first axis electrode 220. It is worth noting that, according to other preferred embodiments of the present invention, the formation of the isolation block 240 and the bridge line 250 on the substrate 110 may be carried out before the formation of the first meshes 220M. In this way, the two separated first meshes 220M can be connected to each other through the bridge line 250.

As shown in FIG. 4 to FIG. 6, the present embodiment provides a touch panel 100 including a substrate 110, a first axis electrode 220 and a second axis electrode 230. The first axis electrode 220 is disposed on the substrate 110 and extends along a first direction X. The first axis electrode 120 includes a plurality of first meshes 120M and at least a bridge line 250. The second axis electrode 230 is disposed on the substrate 110 and extends along a second direction Y. The second axis electrode 230 includes a plurality of second meshes 230M. According to this embodiment, the first axis electrode 220 at least partially overlaps the second axis electrode 230 along a direction Z perpendicular to the substrate 110. An aperture ratio of a region R2 where the first axis electrode 220 overlaps the second axis electrode 230 is substantially equal to an aperture ratio of a region where the first axis electrode 220 does not overlap the second axis electrode 230. In this embodiment, the first axis electrode 220 and the second axis electrode 230 both are disposed on the upper surface 110A of the substrate 110. That is to say, the first axis electrode 220 and the second axis electrode 230 are disposed on the same surface of the substrate 110, but not limited thereto. The bridge line 250 is disposed between the two separated first meshes 220M so as to electrically connect the first meshes 220M. The bridge line 250 may preferably include conductive material, such as at least one chosen from Al, Cu, Ag, Cr, Ti, and Mo, or an alloy thereof. The bridge line 250 may be a single-layered bridge line or a composite-layered bridge line made of the above-mentioned material or alloy, but not limited thereto. Other conductive materials, such as conductive metal oxides or composites composed of conductive metal oxides and metal or alloys, may also be used. In addition, the touch panel 200 may further include at least an isolation block 240 disposed between the bridge line 250 and the corresponding second meshes 230M so as to electrically isolate the bridge line 250 from the corresponding second meshes 230M. That is to say, the bridge line 250 can cross the isolation block 240 disposed on the second meshes 230M in order to have the two separated first meshes 220M electrically connect to each other.

As shown in FIG. 5 and FIG. 7, in the region R2 where the first axis electrode 220 overlaps the second axis electrode 230, the bridge line 250 overlaps an edge of at least a second mesh 230M and has a shape similar to a shape of the edge of the second mesh 230M along the direction Z perpendicular to the substrate 110. That is to say, the line width of the bridge line 250 is preferably substantially equal to that of the first meshes 220M and the second meshes 230M, but not limited thereto. In this design, an aperture ratio of the region adjacent to the bridge line 250, for example, the region R2 shown in FIG. 5 can be equal to an aperture ratio of each first mesh 220M and each second mesh 230M. That is to say, according to the present embodiment, the bridge line 250 is adjusted according to an edge shape of the second mesh 230M underneath the bridge line 250. In this configuration, the decreasing degree of the aperture ratio of the region R2 where the first axis electrode 220 overlaps the second axis electrode 230 affecting by the bridge line 250 can be improved. For example, when each of the second meshes 230M is a right hexagon, the bridge line 250 is preferably a sawn line so as to correspond to the shape of the edge of the second meshes 230M. It is worth noting that, when the alignment variation during the process for manufacturing the bridge line 250 is taken into the consideration, the difference in the aperture ration between the region R2, where the first axis electrode 220 overlaps the second axis electrode 230, and the region, where the first axis electrode 220 does not overlap the second axis electrode 230, is preferably less than 5%. In this configuration, the aperture ratio of the region R2 and the appearance of the touch panel 200 can be improved. Additionally, the first axis electrode 220 and the second axis electrode 232 may be respectively a touch signal transmitting electrode and a touch signal receiving electrode so as to respectively transmit and receive the touch sensing signals. That is to say, the touch panel 200 may be a mutual capacitive touch panel, but not limited thereto.

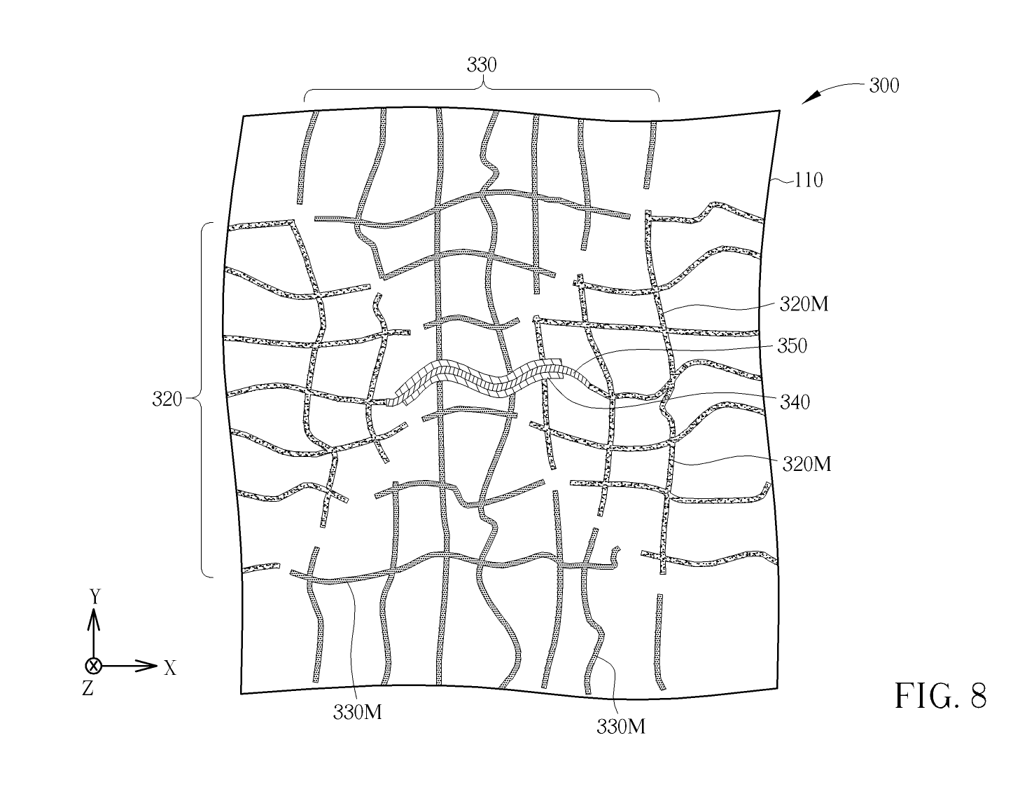

Please refer to FIG. 8. FIG. 8 is a schematic diagram showing a touch panel according to a third preferred embodiment of the present invention. As shown in FIG. 8, the present embodiment provides a touch panel 300. The touch panel 300 includes a substrate 110, a first axis electrode 320, a second axis electrode 330 and an isolation block 340. The first axis electrode 320 is disposed on the substrate 110 and extends along a first direction X. The first axis electrode 320 includes a plurality of first meshes 320M and a bridge line 350. The second axis electrode 330 is disposed on the substrate 110 and extends along a second direction Y. The second axis electrode 330 includes a plurality of second meshes 330M. The difference between this preferred embodiment and the second preferred embodiment is that each first mesh 320M and each second mesh 330M disclosed in this embodiment are respectively meshes with irregular shapes. Each first mesh 320M has a shape different from that of each second mesh 330M. Correspondingly, the bridge line 350 is preferably an irregular line and has the same shape as the edge shape of the second meshes 330M. Apart from the shape of each first mesh 320M, each second mesh 330M and the bridge line 350, the rest of the parts in the touch panel 300 disclosed in this embodiment, as well as the characteristics of other parts, disposed positions and material properties are almost similar to those described in the previous second preferred embodiment. For the sake of brevity, these similar configurations and properties are therefore not disclosed in detail.

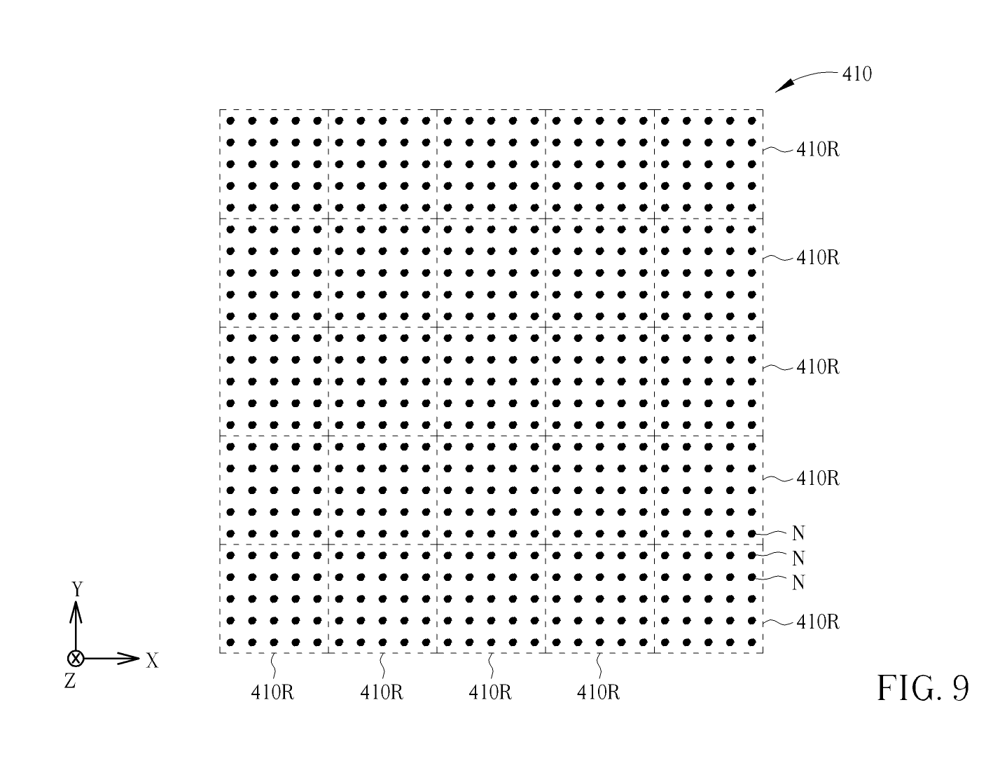

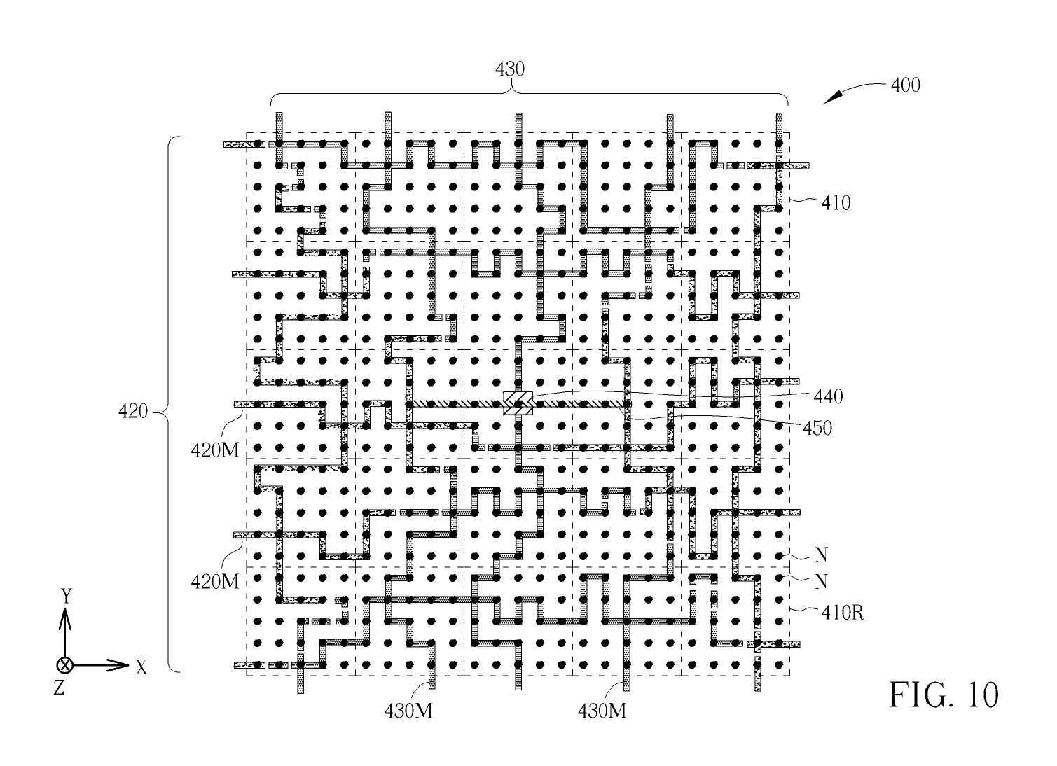

Please refer to FIG. 9 and FIG. 10. FIG. 9 and FIG. 10 are schematic diagrams showing a method for manufacturing a touch panel according to a fourth preferred embodiment of the present invention. The method for manufacturing the touch panel includes the following steps. First, as shown in FIG. 9, a substrate 410 is provided. A plurality of unit matrixes 410R arranged in an array layout is defined on the substrate 410, and a plurality of uniformly arranged nodes N is defined in each unit matrix 410R. The distance between every two adjacent nodes N has a fixed value. In a next step, as shown in FIG. 10, a first axis electrode 420 and a second axis electrode 430 are formed on the substrate 410 so as to form a touch panel 400. The first axis electrode 420 extends along a first direction X and includes a plurality of first meshes 420M and a bridge line 450. The second axis electrode 430 extends along a second direction Y and includes a plurality of electrically connected second meshes 430M. At least a portion of the first meshes 420M is separated from other ones. The bridge line 450 is disposed between the two separated first meshes 420M so as to electrically connect the first meshes 420M. In addition, the touch panel 400 may further include an isolation block 440 disposed between the bridge line 450 and the corresponding second meshes 430M so as to electrically isolate the bridge line 450 from the corresponding second meshes 430M. That is to say, the bridge line 450 can cross the isolation block 440 disposed on the second meshes 430M so that two separated first meshes 420M can be electrically connected through the bridge line 450.

According to this embodiment, the first axis electrode 420 at least partially overlaps the second axis electrode 430 along a direction Z perpendicular to the substrate 410. The first axis electrodes 420, the second axis electrodes 430 or the bridge lines 450 are disposed in each unit matrix 410R. By adjusting the shape of each first mesh 420M and each second mesh 430M, an aperture of each unit matrix 410R may be the same. That is to say, an aperture ratio of a region where the first axis electrode 420 overlaps the second axis electrode 430 is substantially equal to an aperture ratio of a region where the first axis electrode 420 does not overlap the second axis electrode 430. For example, as shown in FIG. 9, a plurality of unit matrixes 410R arranged in an array layout of 5 columns and 5 rows is defined on the substrate 410, and a plurality of uniformly arranged nodes N in an array of 5 columns and 5 rows is defined in each unit matrix 410R. As shown in FIG. 10, the bridge line 450 disclosed in the present embodiment has a straight line shape, but not limited thereto. Apart from the unit matrix 410R having the bridge line 450 (i.e. from the unit matrix 410R in the third row second column to the unit matrix 410R in the third row fourth column), the number of nodes N occupied by each first mesh 420M and/or each second mesh 430M in each of the rest of the unit matrixes 410R is 15. Since the bridge line 450 respectively occupies 3 nodes, 5 nodes and 3 nodes in the unit matrix 410R of the third row second column, in the unit matrix 410R of the third row third column, and in the unit matrix 410R of the third row fourth column, the number of nodes N occupied by each first mesh 420M may be adjusted down to 12 in the unit matrix 410R of the third row second column, the number of nodes N occupied by each first mesh 420M may be adjusted down to 10 in the unit matrix 410R of the third row third column, and the number of nodes N occupied by each first mesh 420M may be adjusted down to 12 in the unit matrix 410R of the third row fourth column. In this way, the aperture ratio among unit matrixes 410R where the bridge line 450 is disposed or is not disposed may be substantially maintained at the same value. Accordingly, the decreasing degree of the aperture ratio caused by the overlapped region between the first axis electrode 420 and the second axis electrode 430 can be improved. Additionally, the difference in the aperture ratio among each of the unit matrixes 410R is preferably less than 5% so that the drawbacks caused by the decreasing of the aperture ratio in a region where the first axis electrode 420 overlaps the second axis electrode 430 can be overcome. Accordingly, the appearance of the touch panel 400 may be improved. It is worth noting that, the number and the arrangement of the nodes N may be modified if required. Additionally, although the disclosure has been illustrated by reference to specific embodiments, it will be apparent that the disclosure is not limited thereto as various changes and modifications may be made thereto without departing from the scope of the present invention.

To summarize, the touch panel disclosed in the present invention uses the meshes to form different directional axis electrodes. By adjusting the shape of the meshes or the bridge lines, an aperture ratio of the region where different directional axis electrodes overlap each other is substantially equal to an aperture ratio of the region where different directional axis electrodes do not overlap each other. In this configuration, the touch response speed can be improved without negatively affecting the appearance of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a first substrate;
at least a first axis electrode, disposed on the first substrate and extending along a first direction, wherein the first axis electrode comprises at least one first mesh; and
at least a second axis electrode, disposed on the first substrate and extending along a second direction, wherein the second axis electrode includes at least one second mesh, the first axis electrode at least partially overlaps the second axis electrode along a direction perpendicular to the first substrate, an aperture ratio of a region where the first axis electrode overlaps the second axis electrode is substantially equal to an aperture ratio of a region where the first axis electrode does not overlap the second axis electrode.

2. The touch panel of claim 1, wherein a difference in the aperture ratio between the region where the first axis electrode overlaps the second axis electrode and the region where the first axis electrode does not overlap the second axis electrode is less than 5%.

3. The touch panel of claim 1, wherein the first mesh has the same shape as the second mesh in the region where the first axis electrode overlaps the second axis electrode.

4. The touch panel of claim 1, wherein at least a portion of the first mesh overlaps at least a portion of the second mesh along the direction perpendicular to the first substrate, and an aperture ratio of a region where the first mesh overlaps the second mesh is substantially equal to an aperture ratio of a region where the first mesh does not overlap the second mesh.

5. The touch panel of claim 1, wherein the first axis electrode is disposed on a lower surface of the first substrate, and the second axis electrode is disposed on an upper surface of the first substrate opposite to the lower surface.

6. The touch panel of claim 1, wherein the first axis electrode and the second axis electrode are disposed on a same surface of the first substrate.

7. The touch panel of claim 1, wherein the first axis electrode further comprises at least a bridge line disposed between two separated first meshes so as to electrically connect the first meshes.

8. The touch panel of claim 7, wherein the bridge line overlaps an edge of at least one of the second meshes along the direction perpendicular to the first substrate.

9. The touch panel of claim 7, wherein the bridge line has a shape similar to a shape of an edge of at least one of the second meshes in the region where the first axis electrode overlaps the second axis electrode.

10. The touch panel of claim 8, further comprising at least an isolation block disposed between the bridge line and the second mesh so as to electrically isolate the bridge line from the second mesh.

11. The touch panel of claim 7, wherein the first substrate further comprises a plurality of unit matrixes arranged in an array layout, and the first axis electrode, the second axis electrode or the bridge line is disposed in each of the unit matrixes, wherein an aperture ratio of each of the unit matrixes is substantially equal to one another.

12. The touch panel of claim 1, wherein the first mesh and the second mesh comprise a mesh having regular shape.

13. The touch panel of claim 1, wherein the first mesh and the second mesh comprise a mesh having irregular shape.

14. The touch panel of claim 6, further comprising an isolation layer disposed on the first substrate, wherein the isolation layer is disposed between the first axis electrode and the second axis electrode.

15. The touch panel of claim 1, further comprising a second substrate disposed opposite to the first substrate, wherein the first axis electrode is disposed on the first substrate and the second axis electrode is disposed on the second substrate.
